(19) United States
(12) Patent Application Publication
(10) Pub. No.: US 2008/0000468 A1
(43) Pub. Date: Jan. 3, 2008

(54) Grill structure

(76) Inventor: Lucas Pai, Taichung City (TW)

Correspondence Address: EGBERT LAW OFFICES, 412 MAIN STREET, 7TH FLOOR, HOUSTON, TX, 77002, US

(21) Appl. No.: 11/477,008

(22) Filed: Jun. 29, 2006

(51) Int. Cl. A47J 37/00

(52) U.S. Cl. 126/25 R

(57) ABSTRACT

The present invention provides a grill structure, having a cylindrical body and an extended wheel set. The cylindrical body forms a containment space inside the cylindrical wall. The extended wheel set includes a wheel frame and a wheel body. The wheel frame has an extended section that extends outward, so that the wheel body is placed on the extended section. The cylindrical body forms a small containment space for the gas tank, which makes the appearance of the grill look light and practical. The extended wheel set offers preferred stability for the grill when it is standing, and preferred easy operation when being moved.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a grill, and more particularly to a new structure of a grill.

### BACKGROUND OF THE INVENTION

Today, people are more involved in outdoor activities, and the demand for outdoor accessories and products is increasing. Among outdoor activities, barbeque is one of the most common ones. Industries have responded to the demand with many different types of grills. The structure of a conventional grill, in terms of the style that has a gas tank, is usually rectangular in shape or with a housing. Therefore, it makes the entire grill look too bulky, taking too much room and being inconvenient to move around.

Moreover, the conventional grill has a wheel body on all corners of the grill, and the wheel body has fixing components to control its fixed or movable state. The disadvantages of the conventional design is that when the user is fixing or moving the grill, the user must switch the fixing component of the wheel body by hand, making it inconvenient when operating. The second style is shown in FIG. 1, which is to place wheel body 11 on half of the bottom of the grill 10, and the other half of the bottom of the grill 10 has stands 12 placed thereon. Therefore, when the grill 10 is standing up, the stands 12 can be in a fixed position. When this grill is standing 10, the other half is still using wheel body 12; therefore, it is not stable. The grill may be rolling when bumped into by other external forces. Moreover, the grill with wheel body 12 on the half of the bottom of the grill 10 is not stable when the area space of the grill 10 is shortened, which is not practical.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention uses the unique structure of the cylindrical body 20 to make a small containment space for a small gas tank 50. The body of the gas tank is also a cylindrical shape. The appearance of the grill A is made to look light and practical.

The present invention uses the unique structure of the extended wheel set 30 to enlarge the space area of the floor part 24 of the cylindrical body 20 when the grill A is standing vertically. Stability is then achieved. When the user desires to move the grill A, the cylindrical body 20 may lean slightly to make the wheel body 32 of the extended wheel roll, making it easy to operate and becoming more practical.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the conventional grill.

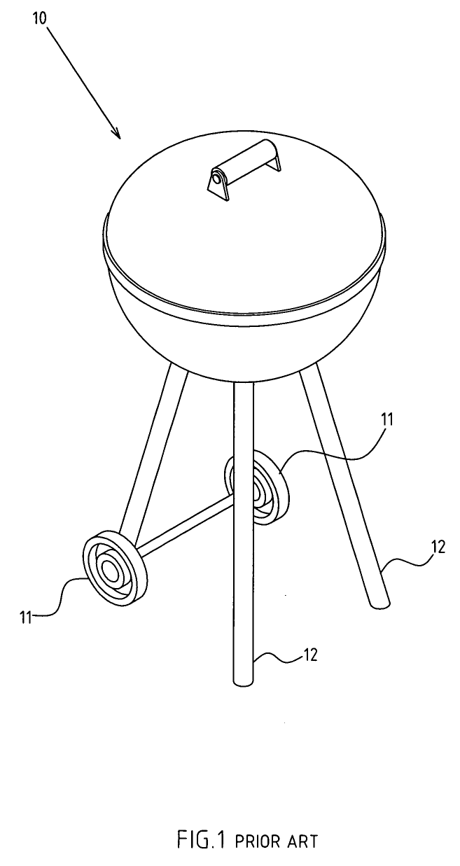

FIG. 2 shows a perspective view of the preferred embodiment of the grill of the present invention.

FIG. 3 shows another perspective view from a different angle, showing the preferred embodiment of the grill of the present invention.

FIG. 4 shows the perspective view of the shutter of the grill being open for a gas tank from the perspective angle of FIG. 3.

FIG. 5 shows a sectional view of the preferred embodiment of the grill of the present invention.

FIG. 6 shows an elevation view of moving the grill of the present invention.

FIG. 7 shows another elevation view of moving the grill of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

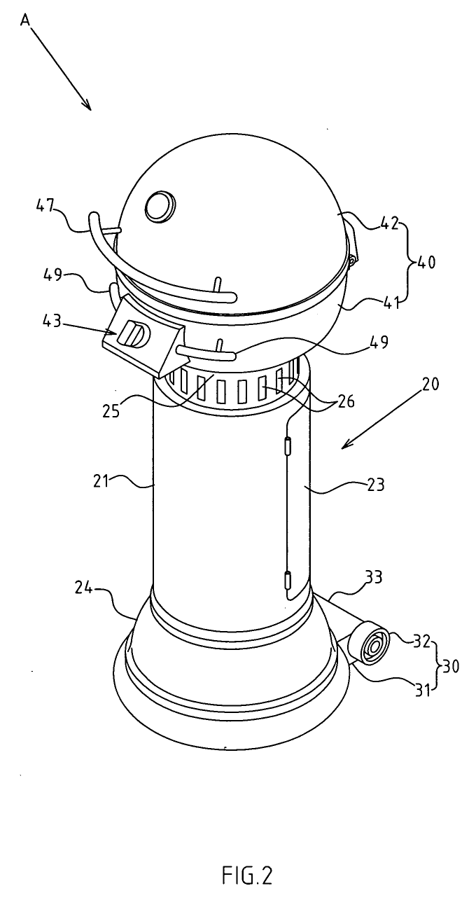

First, as shown in FIGS. 2, 3, 4, 5, there is the preferred embodiment of the grill of the present invention.

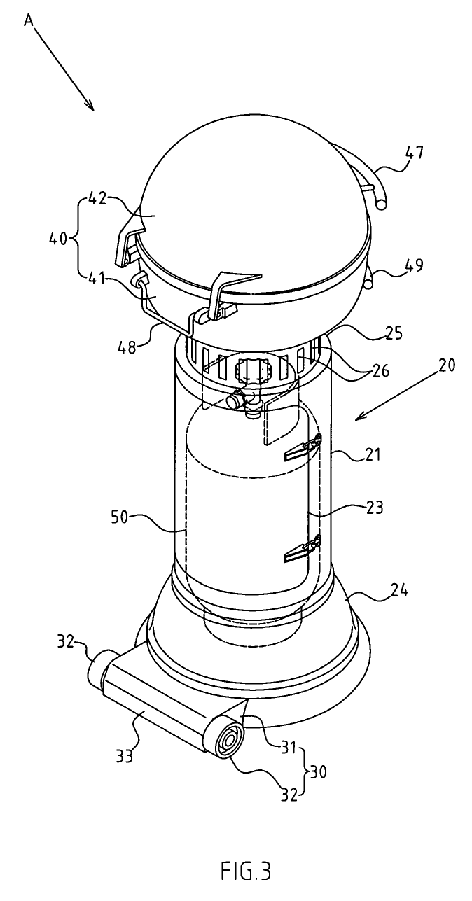

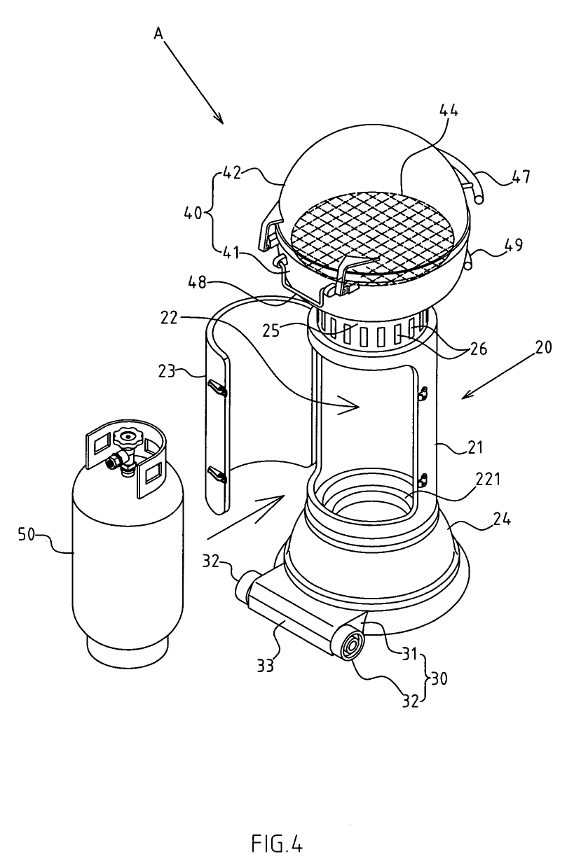

The grill A includes a cylindrical body 20, which includes a vertical cylindrical wall 21, a containment space 22 formed inside of the cylindrical wall 21, and a shutter 23 placed on at least one side of the cylindrical wall 21. The shutter 23 of the present embodiment may be opened from side to side, and the placement of the shutter 23 is to control the opening, as shown in FIG. 4, or closing, as shown in FIG. 3, of the containment space 22. The bottom end of the cylindrical body 20 is a floor type 24, and the top is a connecting part 25 of the oven. The floor part 20 of the present invention extends downward in a cone shape.

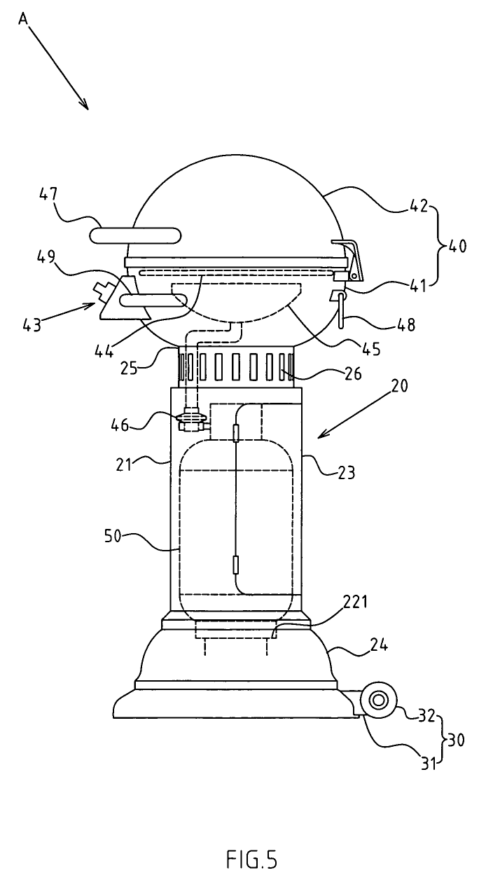

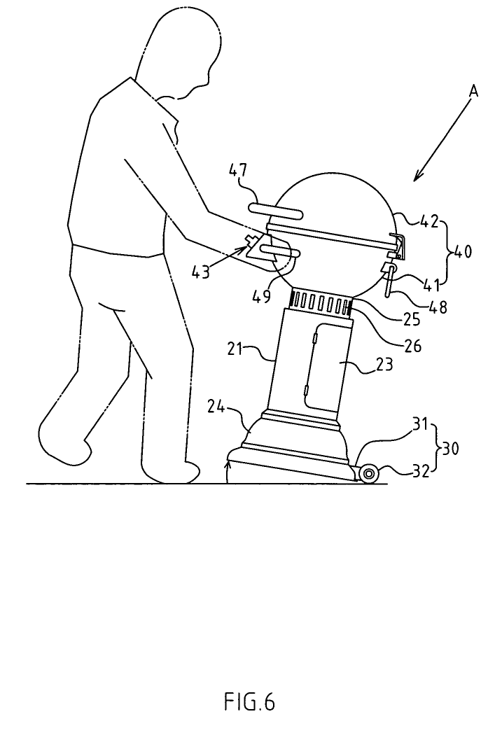

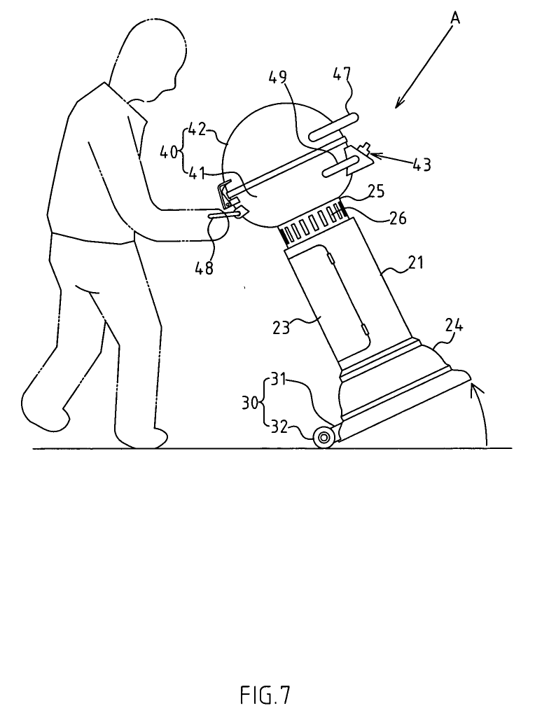

An extended wheel set 30 includes wheel frame 31 and wheel body 32, and one end of the wheel frame 31 is placed on one side of the cylindrical body 24. The other end of the wheel frame 31 has an extended section 33 that extends outward for a predetermined distance. The wheel body 32 can be placed on both sides of the extended section 33. When the cylindrical body 20 is standing vertically, as shown in FIG. 5, the wheel body 32 can be extended outward horizontally or not on the ground. At this time, the floor part 24 of the cylindrical body 20 can be stable. When the cylindrical body 20 is leaning towards the extended wheel set 30, as shown in FIGS. 6 and 7, the floor part 24 of the cylindrical body 20 is made to be hanging in the air, and only the wheel body 32 of the extended wheel set 30 is standing alone.

An oven 40 is placed or connected to the oven connecting part 25 of the oven at the top of the cylindrical body 20. The external side of the oven 40 includes a pedestal 41, an upper cover 42, and an ignition device 43. The ignition device 43 can be placed on the pre-determined area of the pedestal 43, and a grate 44 is included inside the oven.

The present invention also includes a burner 45 and a gas connector 46. The gas connector 46 can be connected with the gas tank 50, so that the gas may be sent to the burner 45, as shown in FIG. 5.

The cylindrical body 20 forms containment space 22 by the cylindrical wall 21 as shown in FIG. 3 and 4, which is enough for a small gas tank 50 to be placed inside with minimum space. A ring-like block edge 221 can be placed on the predetermined height at the bottom of the containment space 22, as shown in FIGS. 4 and 5, for the bottom of the gas tank 50 to be limited.

The pedestal 41 and the upper cover 42 of the oven 40 can be semi-circular, so that the two forms circular shaped oven 40, as shown in FIG. 5.

As shown in FIGS. 4 and 5, air holes 26 may be placed on the predetermined part of the cylindrical body 20, so that the outside air may enter into the containment space 22 of the cylindrical body 20 and into the pedestal 41 of the oven, so that the gas may burn and the heat inside the containment space 22 may be spread.

As shown in FIG. 2, a first handle 47 may be placed on the external side of the upper cover 42 of the oven 40, so that the user may open the upper cover 42. A second handle 48 may be placed on one side of the external side of the pedestal 41 on the same side of the rotating point to open the upper cover 42, as shown in FIG. 4. The second handle 48 may be used for users to move the grill A. A third handle 49 is placed on the ignition device 43 that is placed on the external side of the pedestal 41 of the oven 40, and the third handle 49 of the present embodiment can be placed on both sides of the ignition device 43 so that users may hold and move the cylindrical body 20 at an angle.

Through the above structure and design, the core invention of the grill disclosed in the present invention is the extended wheel set 30 and the wheel frame 31 of the extended wheel set 30 that extends outward to make the wheel body 32 connected to both sides of the extended section 33 of the wheel body 32. When the cylindrical body 20 is standing vertically, as shown in FIG. 5, the wheel body 32 may be extended outward horizontally on the ground, so that the floor part 24 of the cylindrical body 20 can be stable for the entire structure. By extending the wheel body 32, it creates the support to stabilize it. When user desires to move the grill A, for a short distant move, as shown in FIG. 6, the users may stand on the side of the third handle 49, so that the third handle 40 of the pedestal 41 may be lifted. The cylindrical body 20 is leaning slightly towards the extended wheel set 30, at this time, and the floor part 24 of the cylindrical body 20 may leave the floor leaving the wheel body 32 of the extended wheel set 30 on the ground. By so doing, the user may move the grill A easily. When the user desires to move the grill for a long distance, as shown in FIG. 7, the user may stand on the one side of the extended wheel 30 of the cylindrical body 20 holding the second handle 48 of the pedestal 41 to make the cylindrical body 20 lean at a greater angle. By so doing, the wheel body 32 of the extended wheel set 30 is made to roll.

I claim:

1. A grill structure, comprising:
a cylindrical body having a vertical cylindrical wall, a containment space formed inside of said cylindrical wall, and a shutter placed on at least one side of said cylindrical wall, said shutter being able to be opened from side to side, said shutter being placed to control opening or closing of said containment space, said cylindrical body having a bottom end as a floor part;
an extended wheel set, being comprised of a wheel frame and wheel body, one end of said wheel frame being placed on one side of said floor part of said cylindrical body, an opposite end of said wheel frame being an extended section and being able to extend outward for a predetermined distance, said wheel body being placed on said extended section; and
an oven, being placed or connected to a top of said cylindrical body at an oven connecting part of said cylindrical body, an external side of said oven having a pedestal, an upper cover, and an ignition device, said ignition device being placed on a pre-determined area of said pedestal.

2. The structure defined in claim 1, wherein said cylindrical body is standing vertically, said wheel body of said extended wheel set being grounded or hanging in air.

3. The structure defined in claim 1, wherein said cylindrical body forms a containment space through the cylindrical wall for a gas tank to be placed inside.

4. The structure defined in claim 3, wherein said containment space has a predetermined height at a bottom thereof, said bottom having a blocking edge to limit a bottom of said gas tank.

5. The structure defined in claim 1, wherein said pedestal is semi-circular, said oven having an upper cover being semi-circular, said pedestal and said upper cover forming a circular oven.

6. The structure defined in claim 1, further comprising: air holes placed on a predetermined area of said cylindrical body.

7. The structure defined in claim 1, wherein said oven has an upper cover with an external side thereof, said external side having a first handle placed thereof, said pedestal having an external part, said external part having a second handle and a third handle placed thereon.

8. A grill structure, comprising:
a cylindrical body, having a vertical cylindrical wall, a containment space formed inside of said cylindrical wall, and a shutter placed on at least one side of said cylindrical wall, said shutter being placed to control opening or closing of said containment space, said cylindrical body having a bottom end as a floor part and a top end with an oven connection part;
an extended wheel set, being comprised of a wheel frame and wheel body, said wheel frame having one end thereof placed on one side of said floor part, an opposite end of said wheel frame being an extended section and being able to extend outward for a predetermined distance, said wheel body being placed on said extended section; and
an oven, being placed or connected to said oven connecting part of said cylindrical body, an external side of said oven having a pedestal, an upper cover, and an ignition device, said ignition device being placed on a pre-determined area of said pedestal.

9. The structure defined in claim 8, wherein said cylindrical body is standing vertically, said wheel body of said extended wheel set being grounded or hanging in air.

10. The structure defined in claim 8, wherein the wall of said cylindrical body is a cylinder type.

11. The structure defined in claim 8, wherein said pedestal is semi-circular, said oven having an upper cover being semi-circular, said pedestal and said upper cover forming a circular oven.

12. The structure defined in claim 8, further comprising:
air holes placed on a predetermined area of said cylindrical body.

13. The structure defined in claim 8, wherein said oven has an upper cover with an external side thereof, said external side having a first handle placed thereof, said pedestal having an external part, said external part having a second handle and a third handle placed thereon.
